(19) United States
(12) Patent Application Publication
(10) Pub. No.: US 2025/0288923 A1
(43) Pub. Date: Sep. 18, 2025

(54) MOUNT FOR A CARTRIDGE AND METHOD FOR PRODUCING A CARTRIDGE OF A CHROMATOGRAPHY DEVICE

(71) Applicant: Büchi Labortechnik AG, Flawil (CH)

(72) Inventors: Ruben STUBER, Frauenfeld (CH); Stephan BILGER, Mettlen (CH)

(73) Assignee: Büchi Labortechnik AG, Flawil (CH)

(21) Appl. No.: 18/860,434

(22) PCT Filed: Apr. 27, 2023
(86) PCT No.: PCT/EP2023/061064

§ 371 Date: Oct. 25, 2024

(30) Foreign Application Priority Data
Apr. 28, 2022 (EP) 22170431.5

(51) Int. Cl. B01D 15/22

(52) U.S. Cl. CPC B01D 15/222

(57) ABSTRACT

A mount for a cartridge, in particular a cartridge in column chromatography. The mount comprises: a mounting element for force-fitting or frictionally locking connection to at least one end of a cartridge, a detaching element, in particular a push-off sleeve, for releasing the cartridge from the mounting element in the direction of an axis of the cartridge, and an operating device for actuating the detaching element. The detaching element is movable between a neutral position and a detaching position. The cartridge can be mounted on the mounting element when the detaching element is in the neutral position. The cartridge can be separated from the mounting element when the detaching element is moved from the neutral position into the detaching position.

The invention relates to a holder for a cartridge and a method for removing a cartridge of a chromatography device according to the general terms of the independent claims.

So-called flash cartridges for preparative purification in chromatography are usually clamped in a holder. The inlets and outlets on the cartridge are usually standard Luer-Luerlock connections, as with syringes, for example. The luer lock is normally on the inlet side, as the highest pressure is on this side. On the outlet side of the cartridge, only the residual system pressure needs to be taken into account. Until now, the side with the Luer-Lock connection has always been clamped, braked, tilted or fixed in some other way. The problem with this, however, is that after the cartridge has been used, this part of the cartridge jams in such a way that it suddenly comes loose and the remaining media splashes around in the room. On the one hand, this prevents clean working and, on the other hand, the solvent residue can come into contact with the operator. This should be avoided whenever possible.

It is therefore at least one task of the invention to overcome the disadvantages of the prior art. In particular, it is a task of the invention to provide a holder for a cartridge which allows easy insertion and removal of the cartridge after use, is simple and inexpensive to manufacture and enables safe handling of the cartridge. It is also a task of the invention to provide an ergonomic and easy-to-handle holder. It is a further task to provide a method for removing the cartridge from the holder.

The tasks are solved by the independent patent claims. Further embodiments are shown in the dependent patent claims.

A first aspect of the invention relates to a holder for a cartridge, in particular for a cartridge in column chromatography. The holder comprises:
a retaining element for frictional or frictional connection with at least one end of a cartridge,
a release element, in particular an ejector sleeve, for releasing the cartridge from the retaining element in the direction of an axis of the cartridge,
an operating device for actuating the release element.

The release element can be moved between a neutral position and a release position, whereby the cartridge can be held on the holding element when the release element is in the neutral position and whereby the cartridge can be separated from the holding element when the release element moves from the neutral position to the release position.

This holder according to the invention allows particularly easy insertion and removal of the cartridge. The splashing of residual liquids in the cartridge, in particular solvents, can thus be avoided. This in turn ensures clean working and reduces the user's contact with chemicals.

The term “one end of the cartridge” refers to the part of the cartridge to be attached. In commercially available cartridges for chromatography, this is usually a Male-Luer connection.

For proper operation, both ends of a cartridge are usually connected to a pipe system for the passage of a liquid, usually under pressure. During operation, a defined liquid can be pumped in the direction of the axis of the cartridge. Typically, there can be two connection systems: i) on the inlet and outlet side of the cartridge, the inlet and outlet lines into and out of the cartridge are connected with a luer slip; ii) the inlet side of the cartridge (also known as the pressure side) is fitted with a luer lock, while the outlet side of the cartridge has a luer slip. However, it is also possible for both ends to have a luer lock.

It was found that it is sufficient to create a leak only at the Luer connection to ensure proper operation.

“Movable” means in particular that the release element can be swivelled or rotated between a neutral position and a release position.

The holder can have a holding arm for attaching the holder to a wall and/or a frame. It is also possible to attach it to a device such as a chromatography system. However, it is also conceivable that the cartridge holder can do without a holding arm and can, for example, be placed on the cartridge in a free-floating manner.

In particular, the operating device can be rotatable and operatively connected to the release element in such a way that a rotary movement of the operating device causes the release element to move from the neutral position to the release position and/or that the operating device is movable along the axis or transversely to the axis and a movement of the operating device along the axis or transversely to the axis causes a movement of the release element from the neutral position into the release position.

It is also possible for a rotary movement to take place first, followed by a movement of the operating device along the axis or transverse to the axis of the cartridge. The reverse sequence is also conceivable: First, the operating device moves along the axis or transverse to the axis of the cartridge, followed by a rotary movement.

The rotating operating device is particularly ergonomic and enables easy operation, especially with one hand.

The holder can also include a locking device for locking the holder to a frame or housing. Preferably, the locking device is arranged on a holding arm of the holder.

The locking device prevents the bracket from slipping vertically and makes it possible to lock the bracket in a non-slip position for the intended use.

For this purpose, the locking device can have at least one sliding element with toothing which can be brought into engagement with toothing on a frame or a housing, preferably a chromatography housing. The toothing is preferably formed both on the sliding element and on the frame or the housing in the form of teeth, prongs or wedges, which can engage positively in the notches of the respective other component formed by the teeth, prongs or wedges. Preferably, the serrations are asymmetrical.

It is also possible to provide a first sliding element and a second sliding element. In this case, the first and second sliding elements are operatively connected in such a way that a movement of the first sliding element perpendicular to an axis enables a movement of the second sliding element of approx. 30° C. to the axis. The toothing is then preferably arranged on the second sliding element.

The operating device can be brought into a locking position and be operatively connected to the at least one sliding element, and preferably the first sliding element, in such a way that an upward movement of the holder, in particular of the holding arm, is blocked in the locking position.

The at least one sliding element is preferably spring-loaded. Preferably, the first and second sliding elements are springloaded. For example, the second sliding element can be pressed into the teeth of the housing with a spring tensioned by a bolt. Preferably, the teeth are asymmetrical.

Preferably, the operating device has a rotary element, preferably a rotary head, and the rotary element can be rotatable from an initial position into at least one intermediate position and into an end position in a circumferential direction.

The release element and/or the rotary element can have a ramp surface inclined relative to a plane perpendicular to the axis. The ramp surface can effectively connect the rotary element to the release element in such a way that a rotary movement of the rotary element causes a movement of the release element along the axis of the cartridge from the neutral position to the release position.

The ramp surface can have an angle that should be selected so that it is not self-locking. The inclination of the ramp surface can be a first approximation of how easily the cartridge can be released from the holder. A flat angle, for example in the ratio range of length to maximum height of the ramp surface, can be 1.0:0.25, which means that a large angle of rotation is necessary, which requires less release force on the hand. A rather steep angle, for example in the ratio range 1.0:0.75, requires more manual force but a smaller angle of rotation. Ideally, the maximum height of the ramp surface should be 4 mm.

With the ramp surfaces, a particularly efficient release mechanism can be realised in a simple and cost-effective way.

Preferably, the ramp surface of the rotary element has a contour that is at least partially complementary in shape to the ramp surface of the release element, which is particularly preferably formed on a separate counterpart, in particular a counter sleeve.

The rotary element and the counterpart can be operatively connected in the intermediate position in such a way that a subsequent rotation of the rotary element in the circumferential direction causes the counterpart to rotate in the circumferential direction. Rotation in the circumferential direction can, for example, be a clockwise or anti-clockwise rotation.

The intermediate position of the rotary element is advantageously reached after a maximum rotation of 45°, starting from the initial position. If the rotation exceeds 45°, the rotary element and the counterpart can continue to rotate together.

Preferably, the rotary element of the operating device can be rotated into the locking position and is operatively connected to the at least one sliding element in such a way that an upward movement of the holder, and in particular of the holding arm on the frame or on the housing, is blocked in the locking position.

Furthermore, the at least one sliding element of the locking device and/or the rotary element can have a second ramp surface inclined relative to a plane parallel to the axis (x). The second ramp surface can operatively connect the rotary element to the at least one sliding element in such a way that a rotary movement of the rotary element into the locking position causes a movement of the sliding element perpendicular to the axis.

The second ramp surface of the rotary element can have a contour that is at least partially complementary in shape to the ramp surface of the at least one sliding element. In the case of two sliding elements, the ramp surface is preferably arranged on the first sliding element.

The locking position is preferably achieved by rotating the rotary element, starting from the initial position, by at least 45° C. against the rotation to reach the intermediate position of the cartridge.

The holder can have a return spring and the rotary element can be spring-loaded by the return spring for automatic return to the starting position. This allows the rotary element to return to the starting position automatically.

Preferably, the holder can have spring-loaded pins on the operating device and in particular the rotary element, so that the operating device can be automatically returned to its starting position.

Preferably, the spring-loaded pins can be guided via an additional third ramp surface in the rotary element and can engage in the locking position in a recess adjoining the third ramp surface of the rotary element, so that the locking device is locked.

When the holder is used as intended, the toothing can engage with toothing on a frame or a housing due to the displacement of the at least one sliding element.

The locking device is particularly advantageous when the pressure in the cartridge increases and an uncontrolled release of the holder from the cartridge is to be prevented.

In an alternative embodiment, the operating device can comprise a push element, preferably a push button, which is mounted so as to be movable in the direction of the axis or transversely to the axis of the cartridge.

The pressure element can be moved from an initial position to an end position.

Preferably, the release element and/or the pressure element have at least one ramp surface inclined relative to a plane perpendicular to the axis of the cartridge. The at least one ramp surface can operatively connect the pressure element to the release element in such a way that a movement of the pressure element in the direction of the axis or transverse to the axis of the cartridge causes a movement of the release element from the neutral position into the release position. The above remarks on the angle of inclination of the ramp surfaces apply equally here.

Preferably, the at least one ramp surface of the pressure element has a contour which is at least partially complementary in shape to the at least one ramp surface of the release element and which is formed on a, preferably separate, counterpart. The ramp surface can be brought into operative connection with the release element when the ramp surface is moved along the counterpart and the release element can be brought from the neutral position into the release position. Preferably, the release position is reached by reaching the end position of the pressure element.

The at least one sliding element of the locking device and/or the pressure element can preferably have a second ramp surface inclined relative to a plane parallel to the axis. The second ramp surface can operatively connect the pressure element to the at least one sliding element in such a way that a movement of the pressure element into the locking position causes a movement of the sliding element perpendicular to the axis.

The second ramp surface of the pressure element can have a contour that is at least partially complementary in shape to the ramp surface of the at least one sliding element. In the design with two sliding elements, the ramp surface is preferably arranged on the first sliding element.

In the case of the locking device, the end position is preferably reached by reaching the locking position of the pressure element.

The holder with the pressure element can have a return spring and the pressure element can be spring-loaded by the return spring for automatic return to the starting position.

The counterpart can be a mating sleeve.

The operating device of the holders according to the invention can have a height equaliser to accommodate cartridges with connecting sections of different lengths. This enables series production without having to adapt the holder individually to the sizes used.

The counterpart can be mounted so as to be height-adjustable along the axis of the cartridge and, in particular, the rotary element and the counterpart are operatively connected in the intermediate position in such a way that movement of the counterpart along the axis is prevented when the rotary element is between the intermediate position and the end position and the counterpart can be moved along the axis when the rotary element is in the starting position.

The active connection, which prevents the counterpart from moving along the axis, can be realised by interlocking teeth between the operating element and the counterpart.

The toothing on the operating element preferably points in the circumferential direction in the direction of the counterpart, while the toothing on the counterpart advantageously points in the opposite direction to the circumferential direction in the direction of the operating element. The toothing is preferably formed both on the operating element and on the counterpart in the form of teeth, prongs or wedges, which can engage positively in the notches of the respective other component formed by the teeth, prongs or wedges.

The function of the height compensation in relation to the rotary mechanism is explained briefly below: If the cartridge is clamped in the holder, the release element can be pushed into the rotary element as far as the Luer connection, the cartridge design and the pressure force allow. The counterpart can be pushed upwards by the same amount along the axis of the cartridge and is now in a defined height position. If the rotary element is now rotated, the teeth of the rotary element and the counterpart are the first to move together, engage with each other according to the height position of the counterpart (slight correction upwards/downwards by a maximum of one tooth pitch is possible) and thus initiate the remaining rotational movement into the release element by means of the angle, so that the release element is moved from the neutral position into the release position. This results in a downward push.

The release element and in particular the counterpart can also be mounted in a height-adjustable manner in the described pressure mechanism. If the cartridge is clamped in the holder, the release element can be pushed into the holder as far as the Luer connection, the cartridge design and the pressure force allow. The counterpart can be pushed upwards by the same amount along the axis of the cartridge and is now in a defined height position. Several ramp surfaces, preferably three, are attached to the counterpart at discrete intervals. If the pressure element is now actuated, the at least one ramp surface of the pressure element pushes along the at least one ramp surface of the counterpart, thereby pressing the counterpart downwards along the axis of the cartridge, so that the release element is moved from the neutral position to the release position. The cartridge is released from the retaining element.

In a further alternative embodiment, the release element can be designed in the form of a clamping element, for example a clamp or pliers, and the operating element can be designed in the form of a lever that is connected to the clamping element. In the neutral position, the clamping element preferably rests on the cartridge and surrounds or clasps a part of a preferably Luer-Male connection of a cartridge. By actuating the lever provided on the clamping device, the clamping element can be moved from the neutral position to the release position and the cartridge can thus be separated from the holder.

Preferably, the holding element has a Luer female connection. A Luer female connection is compatible with almost all cartridges available on the market for chromatographic and medical purposes.

The holder can be manufactured simply and cost-effectively using injection moulding. Optimised injection moulding processes are particularly preferred. In these processes, reinforcements and ribs are moulded into the components, which provide particular stability while using less material.

Solvent-resistant plastics such as polypropylene (PP), polyethylene (PE), polyether ether ketone (PEEK) or perfluoroethylene propylene (FEP) are particularly suitable for manufacturing the holder.

A further aspect of the invention relates to a chromatography device with at least one holder as described above.

If the holder comprises a locking device as described above, the chromatography device can have an arrangement of teeth, for example in the form of a chain or bar.

The function of the locking device with a sliding element in relation to the rotary element and the chromatography device is explained in more detail below as an example: After the cartridge has been clamped in the holder, the rotary element can be rotated into the locking position. The ramp surface of the sliding element and the ramp surface of the rotary element interact in such a way that the sliding element is moved perpendicular to the axis in the direction of the chromatography device, so that the toothing of the sliding element meshes with the toothing on the chromatography device. A spring-loaded pin in the rotary element locks the rotary element in the locked position and thus the position of the sliding element.

The function of the locking device with two operatively connected sliding elements is explained below as an example. After the cartridge has been clamped in the holder, the rotary element can be rotated into the locking position. The ramp surface of the first sliding element and the ramp surface of the rotary element interact in such a way that the first sliding element is displaced perpendicular to the axis in the direction of the chromatography device. At the same time, the second sliding element moves downwards at an angle of 30° to the axis in the direction of the chromatography device. The toothing is preferably attached to the second sliding element so that the toothing of the second sliding element meshes with the toothing on the chromatography device. A spring-loaded pin in the rotary element locks the rotary element in the locked position and thus the position of the sliding element.

The downward movement of the second sliding element can, for example, be made possible by a spring tensioned by a bolt. Preferably, the bolt is blocked with the spring in the initial position of the rotary element. By turning the rotary element and moving the first sliding element, this blocking is released and the spring presses on the bolt in such a way that the second sliding element is pressed into the toothing of the housing. The asymmetrical teeth lead to self-locking when the bracket moves upwards. At the same time, they allow a downward movement, for example to tighten leakage, without releasing the lock position.

A further aspect of the invention relates to a method for removing or detaching and in particular changing a cartridge of a chromatography device, preferably a chromatography device as described above with a holder for a cartridge as described above. The method comprises the steps:
Optional: Provide a bracket as described above,
Actuating an operating device for actuating a release element,
Due to the actuation of the operating device, movement of a release element from a neutral position to a release position,
Contact of the cartridge with the release element during the movement of the release element,
Separation of a frictional connection between the cartridge and a holding element by moving the release element from a neutral position to the release position,
Optional insertion of a new cartridge into the holding element, which preferably resets the operating device from the detachment position to the neutral position.

The invention is explained in more detail below with reference to examples of embodiments. These are merely particularly preferred embodiments which are not to be understood as limiting. Identical reference symbols characterise identical components. Features shown only in individual embodiments can also be realised with the other embodiments. It shows:

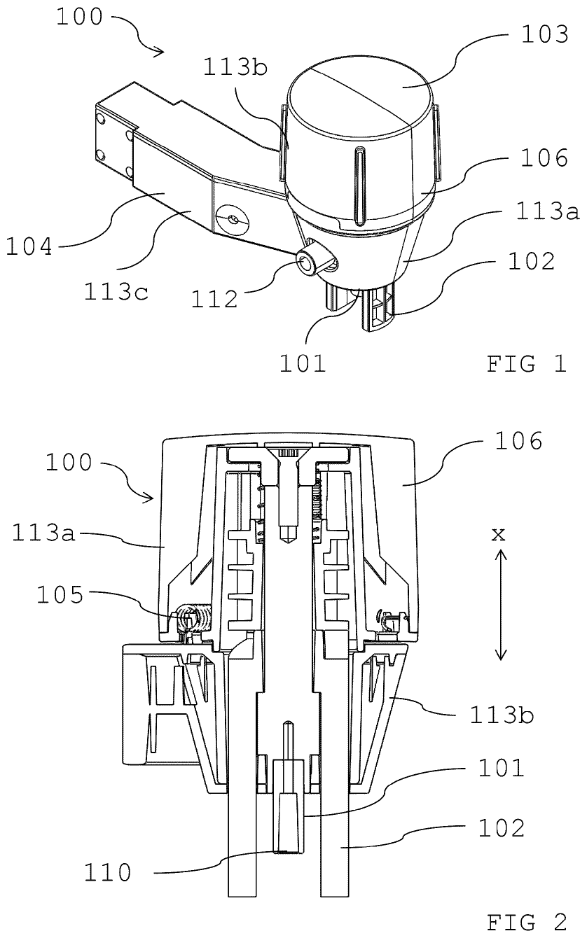

FIG. 1 a perspective view of a first embodiment of a holder with housing according to the invention.

FIG. 2 a cross-section of the first embodiment.

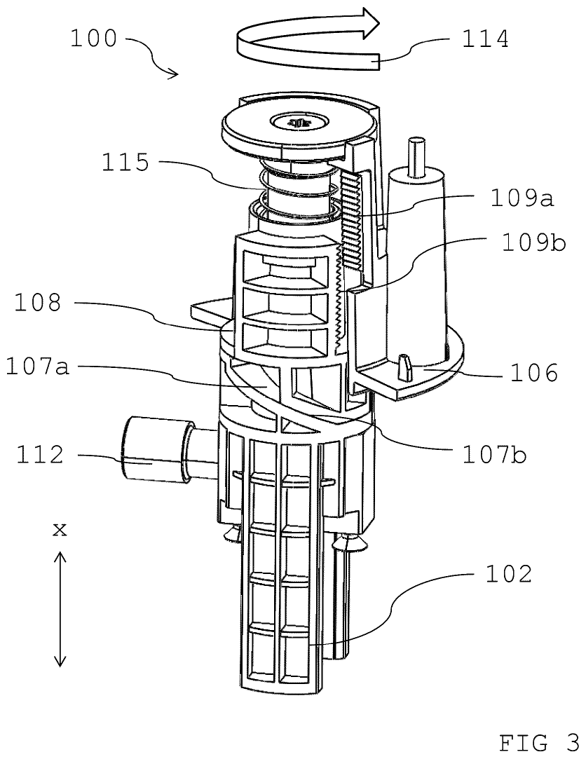

FIG. 3 a perspective view of the first embodiment without housing.

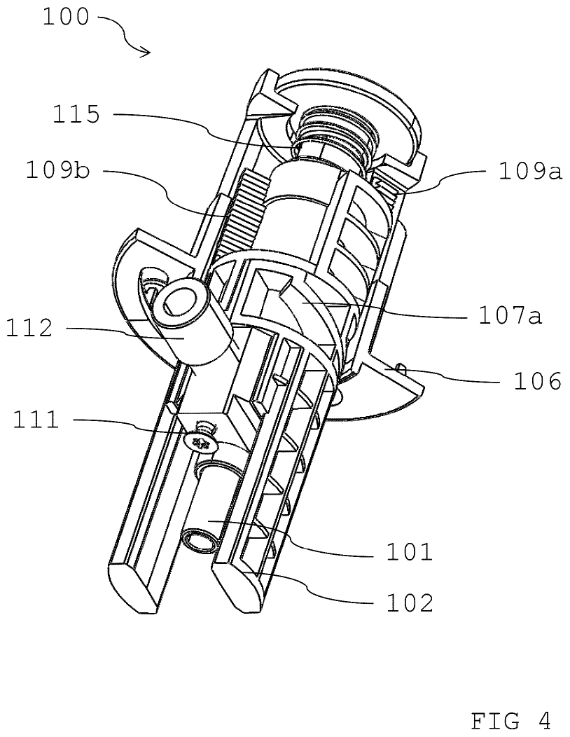

FIG. 4 another perspective view of the first embodiment without housing.

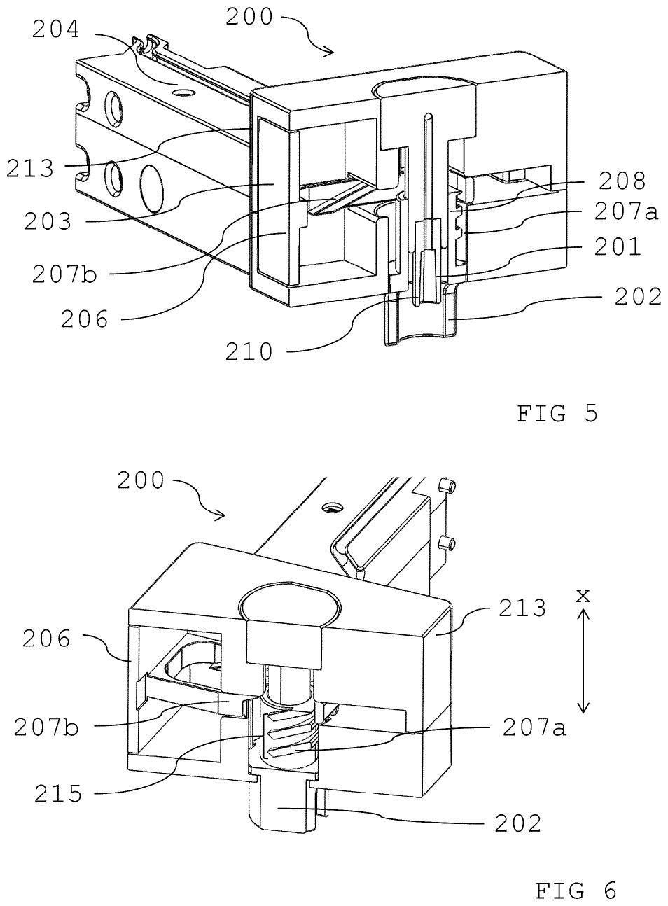

FIG. 5 a perspective sectional view of a second embodiment of a holder according to the invention.

FIG. 6 a second perspective sectional view of the second embodiment.

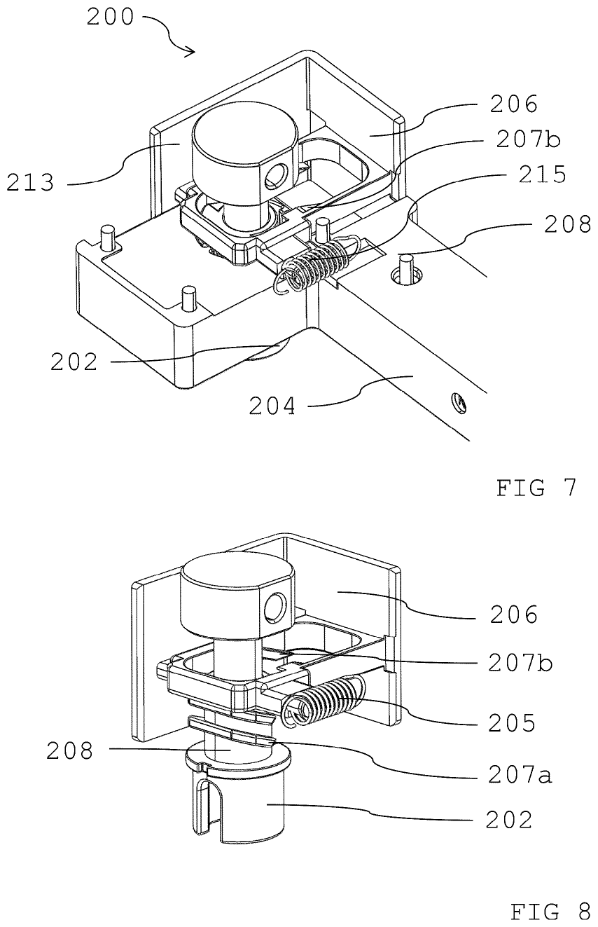

FIG. 7 is a perspective interior view of the second embodiment.

FIG. 8 a second perspective interior view of the second embodiment.

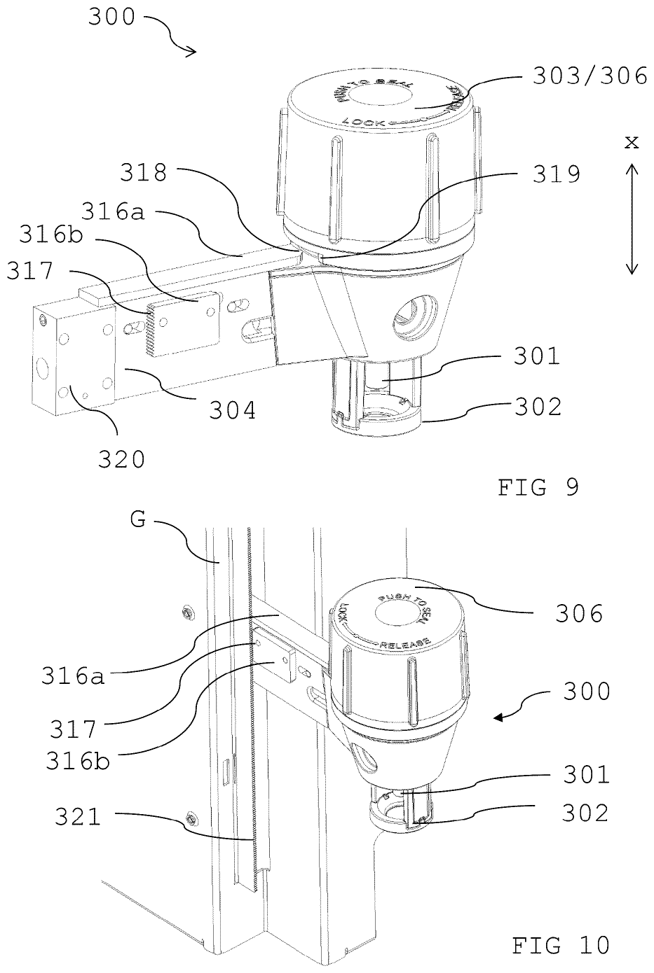

FIG. 9 a perspective view of a third embodiment with a locking device.

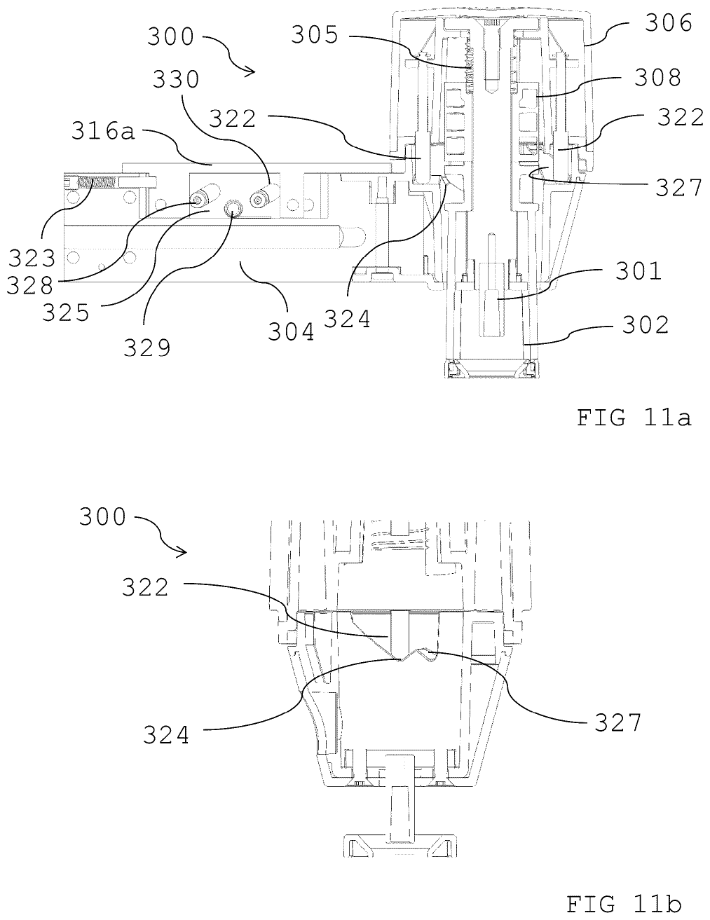

FIG. 10 the embodiment from FIG. 9 on a housing in a non-locked position.

FIG. 11a a sectional view of the third embodiment.

FIG. 11b is a detailed sectional view of the rotary element of the third embodiment.

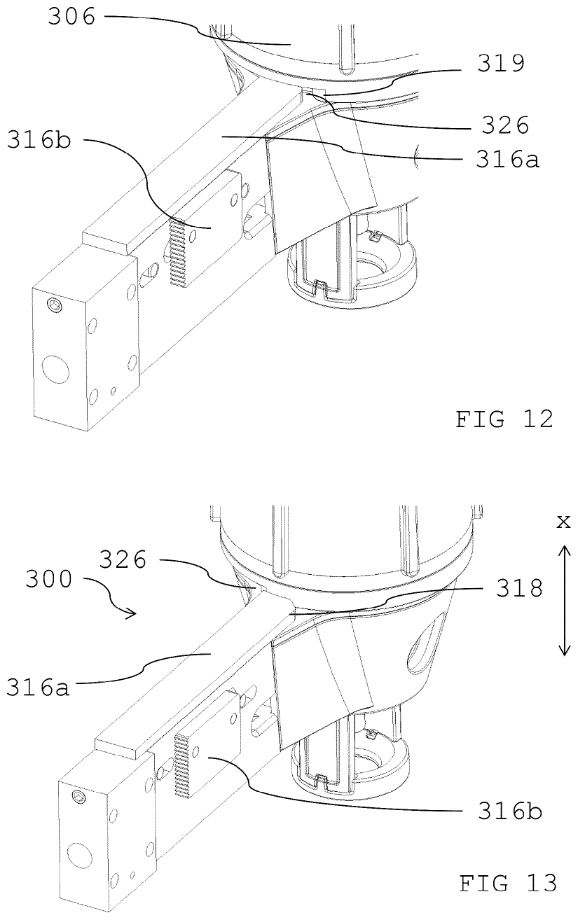

FIG. 12 the position of the sliding element in the nonlocked position according to the third embodiment.

FIG. 13 the position of the sliding element in the locked position.

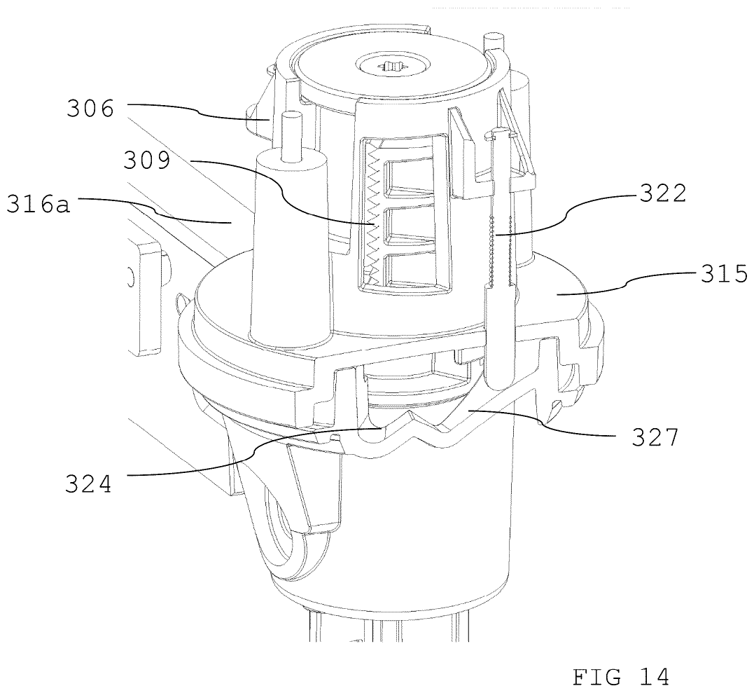

FIG. 14 the release position of the rotary element in the third embodiment without panelling.

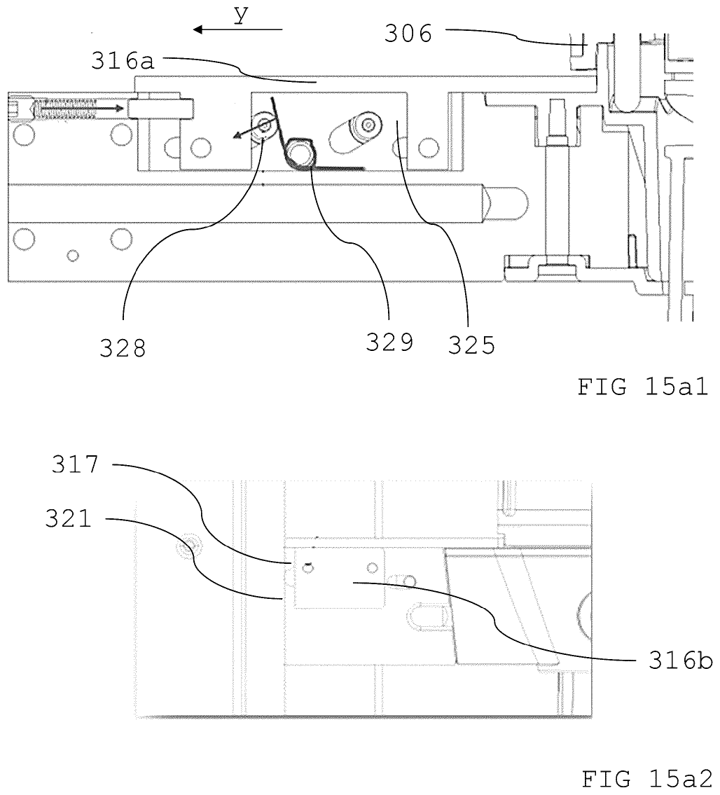

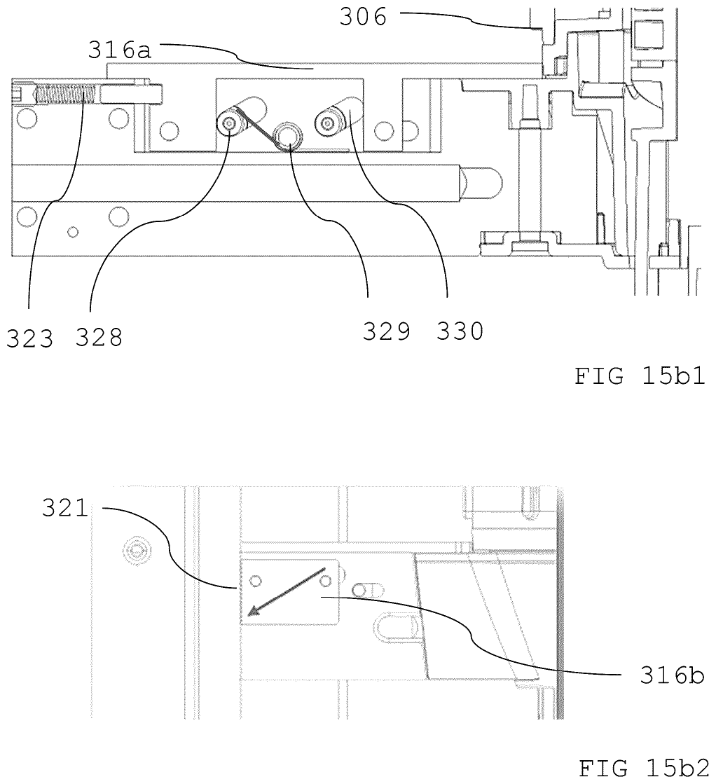

FIGS. 15a-b exemplary design and function of a locking device according to the invention with two sliding elements.

FIG. 1 shows a perspective view of a holder 100 according to the invention. The holder comprises a holding element 101 with a female Luer connection 110 (FIG. 2), a release element 102, an operating element 103 in the form of a rotary element 106. The holder 100 can be connected to a wall, a frame or an appliance (not shown) via a holding arm 104. The rotary element 106, the release element and the holding arm are each surrounded by a panelling 113a, 113b and 113c. The coverings are preferably made of a plastic material and injection moulded.

FIG. 2 shows a cross-section through the panelling 113a and 113b of the holder 100 of the first embodiment. In addition, this figure shows a return spring 115, with which the rotary element 106 can be automatically returned to an initial position after actuation. The cartridge (not shown) is attached to the holding element 101 in the direction of the axis of the cartridge.

FIG. 3 shows the holder 100 according to the invention without housing. The release element 102 has a ramp surface 107a inclined relative to a plane perpendicular to the axis x. The rotary element 106 is operatively connected to the release element via a mating sleeve 108. The mating sleeve has a ramp 107b that is at least partially complementary in shape to the ramp surface 107a of the release element 102. The counterpart 108 also has toothing 109b in the form of serrations, which point anti-clockwise in the direction of the rotary element and can engage with opposite toothing 109a on the rotary element 106. The serrations on the rotary element point in a clockwise direction 114. The serrations 109a and 109b form part of a height equaliser. The height equaliser includes a spring 115, which enables the cartridge to be clamped in the holder 100. Furthermore, a connection 112 is shown which can be connected to an input side of a cartridge (not shown) and thus enables a fluid to pass through the cartridge.

FIG. 4 shows the holder 100 according to the invention without panelling in a further perspective view. In addition to the aforementioned components, a screw connection 111 of the connection 112 can be seen.

FIGS. 5 to 8 show different perspectives of a second embodiment. FIG. 5 shows the second embodiment 200 in a perspective sectional view. Analogous to the first embodiment (100, FIGS. 1 to 4), the holder 200 comprises a holding element 201 with a Luer female connection 210 and a release element 202. In this embodiment, the operating element is designed as a pressure element in the form of a push button. By actuating the pressure element 206, at least one ramp surface 207b can enter into operative connection with at least one ramp surface 207a of the release element 202 and thus release the cartridge (not shown) from the holder 200. The ramp surfaces 207a are attached to a counterpart 208 of the release element 202. The holder 200 can also be connected to a wall, a frame or a device (not shown) via a holding arm 204. Externally, the holder 200 is covered with a panelling 213.

FIG. 6 shows a second perspective sectional view of the second embodiment 200. In addition to the components already described for FIG. 5, several ramp surfaces 207a of the release element can be recognised in this figure. These ramp surfaces 207a form a height compensation 215. Depending on the cartridge used, the counterpart 208 is pushed upwards into the holder to varying degrees in the direction of the axis X of the cartridge, so that either the upper, middle or lower ramp surface 207a enters into operative connection with the ramp surface 207b of the pressure element 206 during detachment.

FIG. 7 shows a perspective interior view of the second embodiment. The panelling 213 has been partially removed. This figure also shows a return spring 215, which serves to bring the pressure element into the starting position. The starting position is given when the spring 215 is completely relaxed.

FIG. 8 shows a second perspective interior view of the second embodiment 200.

FIG. 9 shows a third embodiment 300 in a perspective view. Shown is a holder 300 with a holding element 301, a release element 302 and a rotary element 306 as an operating element 303. The holder also has a holding arm 304, which can be connected to a frame or a housing (not shown) via a mounting block 320. The holder 300 has a locking device comprising a first sliding element 316a and a second sliding element 316b. The sliding elements 316a and 316b are attached to the holding arm 304. The second sliding element 316b has toothing 317, which can enter into operative connection with toothing on a frame or housing.

The first sliding element 316 has a ramp surface 318, which is operatively connected to a second ramp surface 319 of the rotary element 306 in such a way that a rotation of the rotary element into a locking position causes a displacement of the sliding element 316 perpendicular to the axis x.

FIG. 10 shows the holder 300 mounted on a housing G of a chromatography device. The housing G has serrations 321 into which the serrations 317 of the second sliding element 316b of the holder 300 can engage.

FIG. 11a shows a sectional view of the third embodiment. The holder 300 has the holding element 301 and the release element 302 for releasing the cartridge. A counterpart 308 and a height equaliser 305 can be seen inside the rotary element 306. In this embodiment, the return of the rotary element 306 is realised via spring-loaded pins 322. The spring-loaded pins 322 can be guided along an additional ramp 327 in the rotary element 306 when the rotary element 306 is rotated into the different positions. In the locked position of the rotary element 306, these pins 322 can anchor in a recess 324, which preferably adjoins the ramp 327. The sliding element 316a is also mounted via a return spring 323. Furthermore, the sliding element 316a has at least one opening which, when the sliding element 316a is positioned in the locked position, provides space for a downward movement of the sliding element 316b inclined by approximately 30°. The sliding element 316b (not shown here) is held by at least one bolt 328. In the figure, the sliding element 316b is held by two bolts 328. The bolt 328 is displaced along a link 330 by means of a spring 329 and the teeth 317 of the sliding element 316b (FIG. 9) are pressed into the teeth of the housing.

FIG. 11b shows a detailed sectional view of the holder 300. The pin 322 is anchored in the recess 324. The recess 324 adjoins the ramp 327.

FIG. 12 shows the position of the sliding element 316a in the non-locked position. The end of the sliding element 316a is arranged at least partially in a groove 326 of the rotary element 306. The second ramp surface 319 of the rotary element 306 is also recognisable.

FIG. 13 shows the position of the sliding element 316a in the locked position. When the rotary element 306 is rotated into the locked position, the second ramp surface of the rotary element 319 slides along the ramp surface 318 of the sliding element 316a, so that the sliding element 316a is displaced horizontally and perpendicularly to the axis x from the groove 326.

FIG. 14 shows a view of the inside of the rotary element 306 during the release movement. The return spring 315 of one of the pins 322 and the toothing 309 of the height compensation can be recognised. One pin 322 is guided along the ramp 327. The recess 324 for the locking position adjoins the ramp 327.

FIGS. 15a1 to 15b2 are intended to explain an exemplary embodiment and function of a locking device according to the invention with two sliding elements. In FIGS. 15a1 and 15a2, the first sliding element 316a and the second sliding element 316b are shown in their initial position, i.e. non-locked position. The second sliding element 316b does not engage with the teeth 321 of the housing. As can be seen in FIG. 15a1, the second sliding element 316b (rear side FIG. 15a2) is tensioned via a torsion spring 329 arranged via a fastening bolt 328 and blocked against downward movement by the first sliding element 316a with the opening 325. By rotating the rotary element, the first sliding element 316a is moved via the rotary element against the spring force of the spring 323. The movement of the first sliding element 316a in direction y also displaces the opening 325 in direction y and releases the bolt 328 from its blocking. The leg of the torsion spring 329 now presses the bolt downwards along the link 330 (FIG. 15b1), as a result of which the second sliding element 316b performs a movement inclined downwards by 30° and the toothing 317 of the second sliding element 316b is pressed into the toothing 321 of the housing (FIG. 15b2).

The locking device or the sliding elements are now in the locked position. When released back into the initial position, the spring 323 presses on the first sliding element 316a. The first sliding element 316a in turn presses on the bolt 328 and pushes it back into its initial position, whereby the torsion spring 329 is also tensioned again.

1-22. (canceled)

23. A holder for a cartridge, comprising
a retaining element for frictional or frictional connection to at least one end of a cartridge,
a release element for releasing the cartridge from the holding element in the direction of an axis of the cartridge,
an operating device for actuating the release element,
wherein the release element is movable between a neutral position and a release position, wherein the cartridge is retainable on the holding element when the release element is in the neutral position and wherein the cartridge is separable from the holding element when the release element moves from the neutral position to the release position.

24. The holder according to claim 23, wherein the operating device is at least one of
rotatable and operatively connected to the release element in such a way that a rotary movement of the operating device causes a movement of the release element from the neutral position into the release position, and
movable along the axis or transversely to the axis and a movement of the operating device along the axis or transversely to the axis causes a movement of the release element from the neutral position into the release position.

25. The holder according to claim 23, wherein the holder comprises a locking device for locking the holder to a frame or a housing.

26. The holder according to claim 25, wherein the locking device has at least one sliding element with toothing, wherein the toothing can be brought into engagement with toothing on a frame or a housing.

27. The holder according to claim 26, wherein the operating device can be brought into a blocking position and is operatively connected to the at least one sliding element in such a way that an upward movement of the holder is blocked in the blocking position.

28. The holder according to claim 23, wherein the operating device comprises a rotary element and the rotary element is rotatable from an initial position into at least one intermediate position and into an end position in a circumferential direction.

29. The holder according to claim 28, wherein at least one of the release element and the rotary element has a ramp surface inclined relative to a plane perpendicular to the axis and wherein the ramp surface operatively connects the rotary element to the release element in such a way that a rotary movement of the rotary element causes a movement of the release element along the axis from the neutral position into the release position.

30. The holder according to claim 29, wherein the ramp surface of the rotary element has a contour which is at least partially complementary in shape to the ramp surface of the release element and which is preferably formed on a separate counterpart.

31. The holder according to claim 30, wherein the rotary element and the counterpart are operatively connected in the intermediate position in such a way that a subsequent rotation of the rotary element in the circumferential direction causes a rotation of the counterpart in the circumferential direction.

32. The holder according claim 29, wherein at least one of the at least one sliding element of the locking device and the rotating element has a second ramp surface inclined relative to a plane parallel to the axis, and wherein the second ramp surface operatively connects the rotary element to the at least one sliding element in such a way that a rotary movement of the rotary element into the locking position causes a movement of the sliding element perpendicular to the axis.

33. The holder according to claim 32, wherein the second ramp surface of the rotating element has a contour that is at least partially complementary in shape to the ramp surface of the at least one sliding element.

34. The holder according to one of claim 24, wherein the holder has a return spring and the rotary element is spring-loaded by the return spring for automatic return to the starting position.

35. The holder according to claim 23, wherein the operating device comprises a push element, which is mounted so as to be movable in the direction of the axis or transversely to the axis.

36. The holder according to claim 35, wherein at least one of the release element and the pressure element has at least one ramp surface inclined relative to a plane perpendicular to the axis and wherein the at least one ramp surface operatively connects the pressure element to the release element in such a way that a movement of the pressure element in the direction of the axis or transversely to the axis causes a movement of the release element from the neutral position into the release position.

37. The holder according to claim 36, wherein the at least one ramp surface of the pressure element has a contour which is at least partially complementary in shape to the at least one ramp surface of the release element and which is formed on a counterpart, wherein the ramp surface can be brought into operative connection with the release element when the ramp surface is moved along the counterpart, wherein the ramp surface can be brought into operative connection with the release element during a movement of the ramp surface along the counterpart and the release element can be brought from the neutral position into the release position.

38. The holder according to 35, wherein at least one of the at least one sliding element of the locking device and the pressure element has a second ramp surface inclined relative to a plane parallel to the axis, and wherein the second ramp surface operatively connects the pressure element to the at least one sliding element in such a way that a movement of the pressure element into the locking position causes a movement of the at least one sliding element perpendicular to the axis.

39. The holder according to claim 38, wherein the second ramp surface of the pressure element has a contour that is at least partially complementary in shape to the ramp surface of the at least one sliding element.

40. The holder according to claim 23, wherein the operating device has a height equaliser for accommodating cartridges with connecting sections of different lengths.

41. The holder according to claim 30, wherein the counterpart is mounted so as to be vertically adjustable along the axis and wherein, the rotary element and the counterpart are operatively connected in the intermediate position in such a way that movement of the counterpart is prevented from moving along the axis when the rotary element is located between the intermediate position and the end position and wherein the counterpart is movable along the axis when the rotary element is located in the starting position.

42. The holder according to claim 41, wherein the operative connection, which prevents movement of the counterpart along the axis, is realised by interengageable toothing between the operating element and the counterpart.

43. A chromatography apparatus comprising at least one holder according to claim 23.

44. A method for removing a cartridge of a chromatography device, comprising the steps
actuating an operating device for actuating a release element,
due to the actuation of the operating device, moving a release element from a neutral position to a release position,
contacting the cartridge with the release element during the movement of the release element,
separating a frictional connection between the cartridge and a retaining element by moving the detaching element from a neutral position to the detaching position.

45. The method according to claim 44, further comprising the step
insertion of a new cartridge into the holding element, whereby the operating device is preferably reset from the detachment position to the neutral position.
